(19) United States
(12) Patent Application Publication
(10) Pub. No.: US 2008/0008139 A1
(43) Pub. Date: Jan. 10, 2008

(54) System and method for establishing communication network

(75) Inventors: Puneet Gupta, Bangalore (IN); Kartik Muralidharan, Bangalore (IN); Rajat Laxmichand Gogri, Bangalore (IN)

Correspondence Address: NIXON PEABODY, LLP, 401 9TH STREET, NW, SUITE 900, WASHINGTON, DC, 20004-2128, US

(73) Assignee: Infosys Technologies, Ltd., Bangalore (IN)

(21) Appl. No.: 11/480,487

(22) Filed: Jul. 5, 2006

(51) Int. Cl. H04Q 7/24

(52) U.S. Cl. 370/338

(57) ABSTRACT

A system, method, and computer program product for establishing a communication network, including a plurality of access points, wherein each access point includes a plurality of devices adapted to operate in communication to a proximate corresponding access point. The system further includes a communication module disposed in the plurality of devices and encoded with executable instructions representing a computer program, wherein the communication module is adapted to randomly locate the plurality of devices and establish an ad-hoc communication network between the plurality of devices in any of the plurality of access points for exchanging information on the plurality of access points and for establishing the communication network with any of the plurality of access points.

### BACKGROUND OF THE INVENTION

1. Field of the Invention

The invention relates generally to a communication network system between mobile devices and more particularly, to a mechanism for improving wireless communication network by leveraging the inherent mobility of mobile devices.

2. Discussion of the Background

Wireless communication network system typically uses Internet Protocol (IP) to transport packet data representative of voice, video, data or control traffic between endpoints (or “hosts” in IP terminology). In such systems, the data is divided into IP packets called datagrams that include addressing information (e.g., source and destination addresses) that enables various routers forming an IP network to route the packets to the specified destination. The destination address may comprise an address identifying a particular host or an address shared by a group of hosts. Typically, the hosts include various fixed devices and mobile wireless devices, often called mobile terminals that are capable of roaming from site to site or even between different wireless access point (AP) that use IP.

In the field of wireless communication, a hotspot is defined as a readily available wireless network area, covered by the access point. The user with variety of wireless devices in the AP may make use of the internet, download files, send and receive emails in wireless mode. This will only be possible when the user is able to connect to the nearby access point.

Due to the enhanced utility of this wireless communication and mobile internet and intranet access, it is envisioned that multiple mobile devices, which uses IP will be carried within a car, airplane, and train (or even on a person). Such a collection of devices is known as a wireless network and the IP-addressable devices residing within the wireless network are known as wireless network nodes. It would be desirable to provide the communication network for various devices at various locations around one or more access points.

Ad-hoc communication network is a short-range wireless network comprising an arbitrary collection of wireless devices that are physically close enough to exchange information. The ad-hoc network is constructed quickly with mobile wireless devices as they enter and leave the proximity of the remaining mobile wireless devices. The ad-hoc network also may include one or more access points, that is, stationary wireless devices operating as a stand-alone server or as gateway connections to other communication networks.

Although wireless communication is opening the door to a completely new dimension of computing and business practices that propel enterprises to new heights of service and flexibility, however, a number of problems are associated with the wireless communication. The access points and therefore, the hotspot, increase in numbers and thus becomes complex to manage and monitor. The various components that make up a wireless infrastructure, such as servers, companion desktops, etc., require effective monitoring and management, in order to maintain an optimal work environment and increase productivity. In addition, since a variety of mobile devices may proliferate throughout the communication network, it is desirable to secure, manage, monitor and optimize the use of the mobile devices. Furthermore, as different hotspots at any time provide different quality of service because of the local conditions, it becomes difficult to manage these different hotspots and ensure effective connection of the devices with the AP.

Accordingly, there is a need for a technique that enables effective mobility and management of the mobile devices, thereby improving the wireless communication system.

### SUMMARY OF THE INVENTION

In accordance with an exemplary embodiment of the present technique, a system adapted for establishing a communication network is disclosed. The system includes a plurality of access points, wherein each access point includes a plurality of devices adapted to operate in communication to a proximate corresponding access point and a communication module disposed in the plurality of devices and encoded with executable instructions representing a computer program. The communication module is further adapted to randomly locate the plurality of devices and establish an ad-hoc communication network between the plurality of device for exchanging information on the plurality of access points and for establishing the communication network with any of the plurality of access points.

In accordance with another exemplary embodiment of the present technique, a method of establishing a communication network is disclosed. The method includes conducting an inquiry for locating a plurality of devices and wherein the plurality of devices is operable to be connected to at least one access point. The method further includes creating an ad-hoc communication network between the plurality of devices for exchanging information on each of the access points without directly connecting to any of the access points. Furthermore, the method includes comparing the information received for determining quality of service parameters; and informing the plurality of devices on a most suited access point for establishing the communication network with the at least one access point.

In accordance with yet another exemplary embodiment of the present technique, a computer storage device tangibly embodying a plurality of instructions for carrying out a method for establishing a communication network is disclosed. The device includes a computer readable medium and program code adapted for conducting an inquiry and establishing an ad-hoc communication network with a plurality of devices and wherein each device is adapted to operate in communication to its corresponding proximate access point. The device further includes program code adapted for extracting information on the corresponding proximate access point via the ad-hoc communication network. Furthermore, the device includes program code adapted to establish the communication network to the access point after extracting information of the access point via the ad-hoc communication network.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a depiction of a typical system for establishing a communication network between a plurality of devices on a plurality of access points, in accordance with one embodiment of the present technique;

FIG. 2 is a depiction of a system for establishing a communication network illustrating an ad-hoc communication network between the plurality of devices for exchanging information on a plurality of access points, in accordance with one embodiment of the present technique;

FIG. 3 is a depiction of a system for establishing a communication network between a plurality of devices and at least one access point after exchanging information as depicted in FIG. 2, in accordance with one embodiment of the present technique; and

FIG. 4 is a flowchart illustrating a method of establishing a communication network between a plurality of devices for exchanging information on a plurality of access points, in accordance with one embodiment of the present technique.

### DETAILED DESCRIPTION OF THE PREFERRED EMBODIMENTS

The following discussion relates generally to a system for establishing a communication network between a plurality of devices for exchanging information on a plurality of access points in the communication network.

The various implementation discussed herein are generally adapted for improving the efficiency of the communication network. As will be appreciated by persons skilled in the art, communication network refers to a group of two or more devices linked together in a network. In the present context, a device refers to mobile as well as stationary devices, which are adapted to establish connection in the communication network. It should also be noted that devices are also referred as peers in the communication network terminology. There are many types of communication networks, which includes local-area networks (LANs), wherein the devices are geographically close together (that is, in the same building). The second type of communication network is wide-area networks (WANs), wherein the devices are farther apart and are connected by telephone lines or radio waves. The third type of communication network is campus-area networks (CANs), wherein the devices are within a limited geographic area, such as a campus or military base. Lastly, metropolitan-area networks (MANs), which refer to a data network designed for a town or city.

It should also be noted that in the communication network, each device is connected to an access point. Access point provides a radio coverage area or a region and are operable to allow the at least one device to provide a connection within the radio coverage area for establishing the communication network. The radio coverage area or the region is also referred as a “hotspot”.

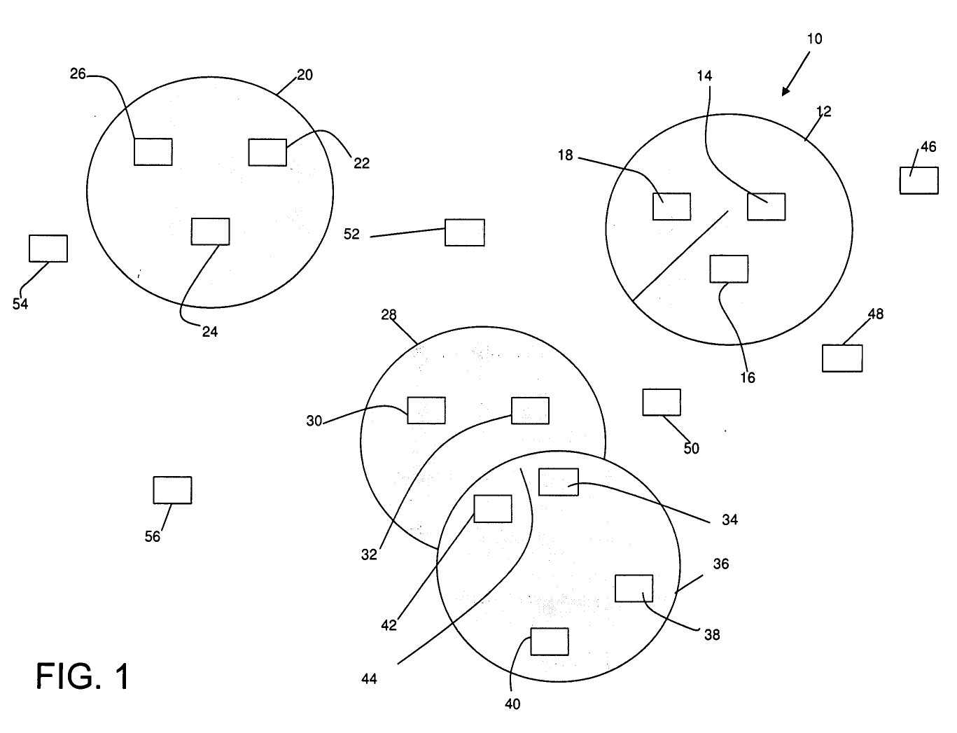

In order to understand and appreciate the various aspects of the present technique, the following sections provide brief introduction to the various aspects of the communication network. In particular, FIG. 1 is a depiction of a typical system 10 adapted for establishing a communication network between a plurality of devices on a plurality of access points, in accordance with one embodiment of the present technique. In way of example, the system 10 includes access point 12 includes devices 14, 16 and 18. Similarly, access point 20 includes devices 22, 24, and 26. Likewise, access point 28 includes devices 30, 32, and 34 and access point 36 includes devices 38, 40, and 42. The devices in each of the access points are connected to their respective access points and establish the communication network. However, in one implementation of the present technique, devices 46, 48, 50, 52, 54, and 56 may not be directly under any access points.

Furthermore, the illustration in FIG. 1 depicts the plurality of access points (12, 20, 28, and 36) at various locations within the same building or at various other locations such as CANs or WANs. As illustrated in FIG. 1, each access point includes a range or the areas represented by reference numeral 42. The plurality of devices are connected to the respective access points as represented in FIG. 1. As will be appreciated by people skilled in the art, in some occasions, the range of the one or more access points may overlap each other as indicated by reference numeral 44. In such a situation the plurality of devices located nearby (34, 42) to both the access points can establish the communication network using the range of any of the overlapping access points. As mentioned earlier, the devices 46, 48, 50, 52, 54, and 56 may not be directly under any access points. These devices may get connected to any of the access points if the devices come within the range of any of the access points during their mobility.

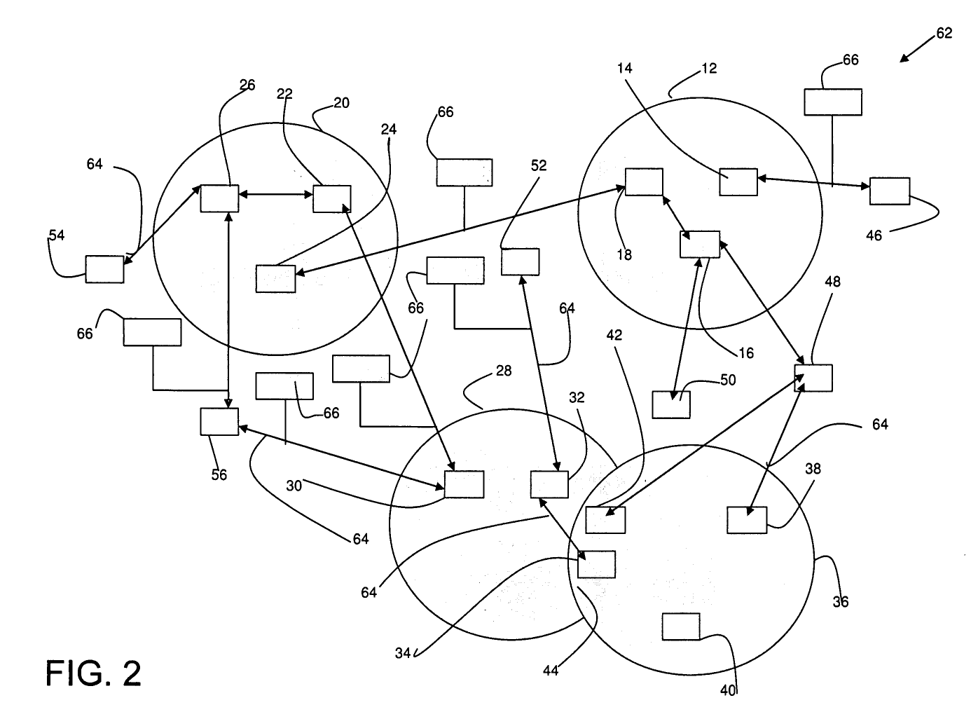

FIG. 2 depicts a system 62 for establishing a communication network illustrating an ad-hoc communication network 64 between the plurality of devices for exchanging information on a plurality of access points, in accordance with one embodiment of the present technique. As explained with respect to FIG. 1 above, the system 62 includes the plurality of devices accessible to the plurality of access points. When the plurality of devices is proximate to each other, a communication network is established between the plurality of devices called as the ad-hoc communication network.

Ad-hoc communication network is a short range wireless system comprising an arbitrary collection of devices that are physically close enough to establish a communication network for exchanging information. The ad-hoc network is constructed quickly with devices joining and leaving the network as they enter and leave the proximity of the remaining devices. The ad-hoc network may also include one or more accessible points, that is, stationary wireless devices operating as a stand alone server or as gateway connections to other networks. In the present context, the ad-hoc communication refers to the communication between devices connected to the same access point or different access points.

It should be noted that ad-hoc communication network may be established when the plurality of devices are within their accessible range. This range may be referred as the ad-hoc communication network range. This range may however, vary with respect to the configuration of the devices. In addition to this, the ad-hoc communication network range and the range 42 of the access point as described with reference to FIG. 1, may or may not be the same. Furthermore, in some implementation of the present technique, the plurality of devices may be in a position to establish the ad-hoc communication network but may not be able to establish the communication network with any of the access points due their location with respect to the range of the access point.

In some other implementation of the present technique, the plurality of devices may be able to establish the communication network with at least one access point when the device is within the range of that access point. In such a situation, the plurality of devices may not be in a position to establish the ad-hoc communication network with other devices due to ad-hoc communication network range.

Keeping in mind the preceding discussions, FIG. 2 depicts the ad-hoc communication network 64 between the plurality of devices. In the ad-hoc networking scenario, two or more devices located proximate to each other may establish connection between the devices for exchanging information between the devices. The information indicated by reference numeral 66 may be pertaining to the access points to which the particular device is presently connected. To establish the ad-hoc communication network, each device includes a communication module (not shown for clarity), which is encoded with executable instructions representing a computer program. The communication module may be adapted to randomly locate the plurality of devices during their mobility and establish the ad-hoc communication network.

In one implementation of the present technique, the communication module may also be configured to provide authentication between the plurality of devices prior to establishing the ad-hoc communication network. This will be explained in detail in the subsequent sections.

Referring back to FIG. 2 and as depicted, the device 30, which is presently connected to access point 28, may establish the ad-hoc communication 64 with the device 22, which is connected to access point 20. In such a situation, both the devices 30 and 22 exchange information 66 on each of the access points (28 and 20). In a typical situation, the information 66 of each of the access points are stored in each of the device in an extensible mark-up language (XML) schema. The information is stored in a memory unit (not shown for clarity) in each of the devices. The exchange of information 66 after establishing the ad-hoc communication network is also executed in the XML schema.

In one implementation of the present technique, the information 66 may be related to the load of the devices on each of the access points for load balancing of the plurality of devices on each of the access points. Load Balancing is the distribution of the plurality of devices across multiple access points. This applies to the access point load as a whole in the communication network. With load balancing, one can ensure that all access points on the network handle a proportionate share of the plurality of devices, and that no single access point gets overloaded. Using load balancing, one can prevent scenarios where a single access point in the network may show performance degradation because of handling a disproportionate share of the plurality of devices. This information may be shared between the pluralities of devices through the ad-hoc communication network. Furthermore, the information 66 on the load, guides the devices to establish a communication with the access point having fewer loads of the devices. The details of the load distribution will be explained in further details in the subsequent section.

In yet another implementation of the present technique, the information 66 may be related to the configurable parameters of the access points or the quality of service of the access points. Quality of service (QoS) is essential for enabling the widespread deployment of wireless multimedia applications such as cordless voice of internet protocol (VoIP) phones for enterprise WLANs as well as for wireless bridges between analog audio-video equipment and personal computers serving up digital content in the home. As loads comprising of the plurality these above mentioned devices increase on the access points, the data of the plurality of devices are lost because the data nodes contend with each other to determine which one will get to transmit. QoS schemes seek to improve the reliability of data and reduce contention overhead, thereby increasing the effective bandwidth of transmission. In one aspect of the present technique, the system 62 further includes a decision device (not shown for clarity), which is adapted to compare a present requirement on quality of service parameters of the plurality of access points and then guide the plurality of devices on the best suited access point.

In yet another implementation of the present technique, the information 66 may be related to the configuration parameters of each of the access points. This information 66 on the configurable parameters provides a guideline to the devices for establishing a communication network with the access point.

It should be noted that though reference is made to the information 66 relating to the load of the devices on each of the access points or the configurable parameters of the access points or the quality of service of the access points or combinations thereof, other information known in the art may include but not limited to connectivity details or throughput of the communication network or packet drop rate of the communication network or location information of the access points and the devices connected to the particular access points or combinations thereof.

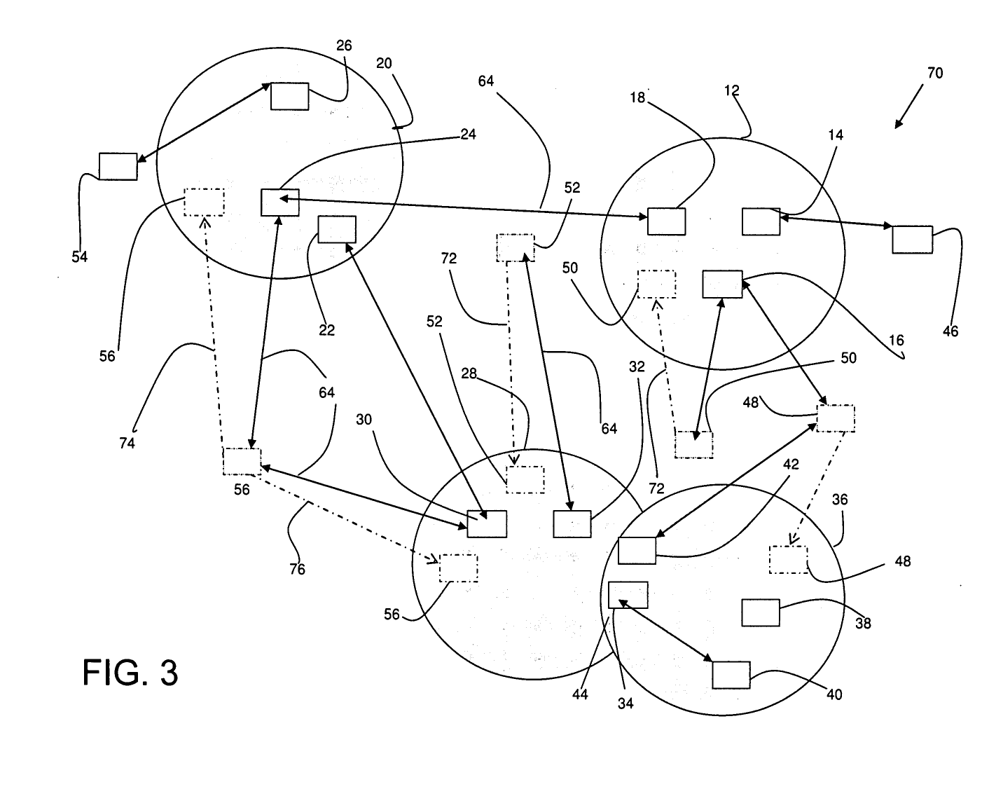

While the preceding discussions refers to the exchange of information 66 between the plurality of devices through the ad-hoc communication network, FIG. 3 depicts a system 70 for establishing a communication network between the plurality of devices and at least one access point, in accordance with one embodiment of the present technique. As illustrated in FIG. 3, the plurality of devices after exchanging information between each other decides on the most suitable access points and establishes a connection between the plurality of devices and the access point by moving inside the range 42 of the particular access point. This is generally represented by reference numeral 72. As depicted, the device 50 exchanges information with device 16 in the access point 12. After receiving the information on the access point 12, the device 50 may move proximate to the access point 12 and may come within the range of the access point 12. This aids in the device to acquire connectivity with access point 12. Likewise, device 52 after acquiring information on the access point 28 via the device 32 through the ad-hoc communication network may move close to the range of the access point 28 and establishes connectivity with the access point 28.

In one implementation of the present technique, the device 42 may not have network accessibility to acquire information on access point 12. In such a situation, the device 42 acquires information on the access point 12 by establishing the ad-hoc communication network with the device 48. As depicted in FIG. 3, device 48 contains information on access point 12 via the ad-hoc communication network with device 16 and therefore, shares this information on the access point 12 with the device 42 when they are connected through the ad-hoc communication network. In this way, device 42 acquires information on the access point 12.

In another implementation of the present technique, a particular device may be operable to exchange information between one or more devices at the same time. In such a situation as depicted in FIG. 3 above, the device 56 may establish the ad-hoc communication network with the device 30 of access point 28 and device 24 of access point 20 at the same time. In such a situation, the device 56 may have the option of acquiring information on both the access points 28 and 20. Depending on the load of the plurality of devices or the configurable parameters on each of the respective access points 28 and 20 or the other information as mentioned earlier, the device 56 may have the option of establishing the communication network with either of the access points 28 or 20. This is indicated by reference numeral 74 and 76 respectively.

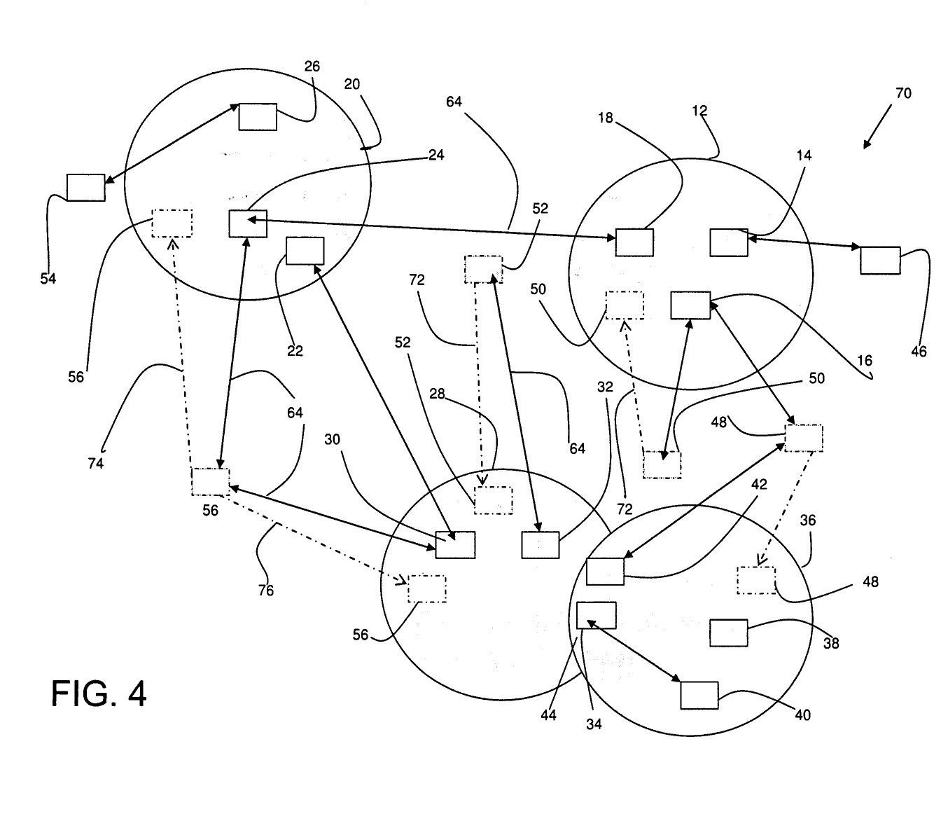

FIG. 4 depicts a flowchart illustrating a method 84 of establishing a communication network between the plurality of devices for exchanging information on the plurality of access points, in accordance with one embodiment of the present technique. As illustrated, the method 84 begins by conducting an inquiry to locate the plurality of devices, wherein each device is operable to be connected to at least one access point (block 86). As discussed herein above, one device may be operable to connect to more than one access point at the same time due to the overlap between the range of two or more access points or due to its position being proximate to more than one access point. At step 88, the plurality of devices establishes the ad-hoc communication network between the plurality of devices for checking the authentication between the plurality of devices. The authentication may also include authorization and request for permission to establish the ad-hoc communication network.

In one implementation of the present technique, the authentication may not be required and therefore, the communication network between the plurality of devices may be achieved automatically. After the authentication is completed, at step 90, the information stored on the access point on each of the devices may be exchanged. As mentioned earlier, the plurality of devices store the information on their respective access points in an XML schema, when they are connected to the access points. During the ad-hoc communication network, the plurality of devices is operable to extract information from each other and exchange the extracted information. This exchange of information on each of the access points may be achieved by the ad-hoc communication network, without directly connecting to any of the access points.

The method continues in step 92, wherein the information between the plurality of devices are compared for establishing the communication network between the plurality of devices and any of the access points. This is generally executed by the decision device as mentioned earlier. As discussed above, the information exchanged between the plurality of devices includes are but not limited to at least one of connectivity variables, available nearby access points, load on each of the plurality of access points, throughput, packet drop rate, security parameters or configurable parameters of the plurality of devices and the plurality of the access points or combinations thereof.

It should be noted that in one implementation of the present technique, the decision device helps in indicating the plurality of devices on the best suited access point depending on the information shared. In another implementation of the present technique, the decision device helps to compare the present requirement on quality of service parameters of the plurality of access points.

The method further continues in step 94, wherein the plurality of devices gets connected to at least one of the access points based on the exchange of information and the decision device. In this way, the plurality of devices may get connected to the best suited access point based on the information exchanged between the plurality of devices. Finally, at step 96, the plurality of devices periodically updates and exchanges the information between the plurality of devices via the ad-hoc communication network. The above method continues as the devices keep on establishing the ad-hoc networking.

The method described above is stored as a computer program product, which performs the methods of the disclosed invention by executing specified sequences of operational instructions. The sequence of instructions may be altered at any stage depending on the requirement.

As will be appreciated by those of ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The sequence of instructions as explained in the method steps may include a program code adapted for conducting an inquiry and establishing the ad-hoc communication network between the plurality of devices, wherein each device is adapted to operate in communication to its corresponding proximate access point. The sequence of instructions also include a program code adapted for extracting information on the corresponding proximate access point via the ad-hoc communication network and another program code adapted to establish the communication network to the access point after extracting information of the access point via the ad-hoc communication network. Furthermore, the sequence of instructions may include a program code adapted for providing information on the load on the access points and generating a response to each of the devices for distributing the load on each of the access points and another program code adapted for comparing a present requirement with quality of service (QOS) parameters of each of the access points via a decision device.

As will be appreciated by a person skilled in the art, the various implementations of the present technique provide a variety of advantages. For example, the present technique involves the exchanging of information during the ad-hoc communication network between the plurality of devices. The information exchanged aids in establishing a communication network between the plurality of devices and any of the access points on which the information is exchanged. Secondly, due to the exchange of information on the access points, the load distribution of the plurality of devices on each of the access points are acquired. This information is useful for distributing and guiding the plurality of devices for changing the access points for better and efficient communication network. The present technique, further, facilitates improving the quality of service of the plurality of devices.

While only certain features of the invention have been illustrated and described herein, many modifications and changes will occur to those skilled in the art. It is, therefore, to be understood that the appended claims are intended to cover all such modifications and changes as fall within the true spirit of the invention.

What we claim is:

1. A system adapted for establishing a communication network, comprising:
a plurality of access points, wherein each access point comprising:
a plurality of devices adapted to operate in communication to a proximate corresponding access point; and
a communication module disposed in the plurality of devices and encoded with executable instructions representing a computer program, wherein the communication module is adapted to randomly locate the plurality of devices and establish an ad-hoc communication network between the plurality of devices in any of the plurality of access points for exchanging information on the plurality of access points and for establishing the communication network with any of the plurality of access points.

2. The system as recited in claim 1, wherein the plurality of devices include mobile or fixed devices.

3. The system as recited in claim 1, wherein the plurality of devices are adapted to store the information of the corresponding access point during a period of connection between the plurality of devices and the corresponding access point.

4. The system as recited in claim 1, wherein the information guides the plurality of devices to connect to any of the plurality of access points.

5. The system as recited in claim 1, wherein the information comprising at least one of connectivity variables, or available nearby access points, or load on each of the plurality of access points, or throughput, or packet drop rate, or security parameters or configurable parameters of the plurality of devices and the plurality of the access points or combinations thereof.

6. The system as recited in claim 1, wherein the information between the plurality of devices in the plurality of access points are stored in an extensible mark-up language (XML) schema.

7. The system as recited in claim 1, wherein the communication network between the plurality of devices are dynamic and automatic.

8. The system as recited in claim 1, further comprising a decision device configured to compare a present requirement on quality of service (QOS) parameters of the plurality of access points.

9. The system as recited in claim 1, further comprising a service adapted to provide a visualization of associations between the plurality of devices connected to the corresponding access point.

10. The system as recited in claim 1, further comprising a first protocol module adapted to request an authorization from each user of the device prior to connection between the plurality of devices.

11. A method of establishing a communication network, comprising the steps of:
conducting an inquiry for locating a plurality of devices, wherein the plurality of devices are operable to be connected to at least one access point and is adapted to store information on their respective access points;
establishing an ad-hoc communication network between the plurality of devices for exchanging information on their respective access points;
comparing the information received between the plurality of devices for deciding on establishing the communication network between the plurality of devices and any of the access points; and
establishing the communication network between the plurality of devices and the at least one access point after based on the information exchanged.

12. The method as recited in claim 11, wherein the information comprising at least one of connectivity variables, or available nearby access points, or load on each of the plurality of access points, or throughput, or packet drop rate, or security parameters or configurable parameters of the plurality of devices and the plurality of the access points or combinations thereof.

13. The method as recited in claim 11, further comprising providing information on the load on the at least one access point.

14. The method as recited in claim 11, wherein the information is stored in an extensible mark-up language (XML) schema.

15. The method as recited in claim 11, wherein establishing the communication network between the plurality of devices is dynamic and automatic.

16. The method as recited in claim 11, wherein deciding on establishing the communication network with the at least one access point further comprising comparing a present requirement with quality of service (QOS) parameters of each of the access points using a decision device.

17. The method as recited in claim 11, further comprising periodically updating the information on each of the access points.

18. The method as recited in claim 11. wherein the exchange of information between the plurality of devices occurs periodically.

19. A computer storage device tangibly embodying a plurality of instructions for carrying out a method for establishing a communication network, comprising:
a computer readable medium storing:
program code adapted for conducting an inquiry and establishing an ad-hoc communication network between a plurality of devices, wherein each device is adapted to operate in communication to its corresponding proximate access point;
program code adapted to extract and store information on its corresponding proximate access point in the plurality of devices;
program code adapted for exchanging information between the plurality of devices on each of the corresponding proximate access point via the ad-hoc communication network; and
program code adapted to establish the communication network to any access point after exchanging information of their corresponding proximate access point via the ad-hoc communication network.

20. The computer storage device as recited in claim 19, wherein the computer readable medium stores the information of the access point in an extensible mark-up language (XML) schema.

21. The computer storage device as recited in claim 19, wherein the program code adapted for conducting the inquiry further comprising a first program code adapted for sending a request message to each of the plurality of devices and a second program code adapted for receiving a recognition response from the each of the plurality of devices for establishing the ad-hoc communication network.

22. The computer storage device as recited in claim 19, wherein the information comprising at least one of connectivity variables, or available nearby access points, or load on each of the plurality of access points, or throughput, or packet drop rate, or security parameters or configurable parameters of the plurality of devices and the plurality of the access points or combinations thereof.

23. The computer storage device as recited in claim 19, further comprising a program code adapted for providing information on the load on each of the access points and generating a response to each of the plurality of devices for distributing the load on each of the access points.

24. The computer storage device as recited in claim 19, further comprising a program code adapted for comparing a present requirement with quality of service (QOS) parameters of each of the access points via a decision device.
